(19) United States
(12) Patent Application Publication
(10) Pub. No.: US 2024/0036310 A1
(43) Pub. Date: Feb. 1, 2024

(54) EYE-TRACKING SYSTEM AND METHOD EMPLOYING SCANNING

(71) Applicant: Pixieray Oy, Espoo (FI)

(72) Inventor: Klaus Melakari, Espoo (FI)

(73) Assignee: Pixieray Oy, Espoo (FI)

(21) Appl. No.: 17/876,740

(22) Filed: Jul. 29, 2022

(51) Int. Cl. G02B 27/00; G02B 27/01

(52) U.S. Cl. CPC G02B 27/0093; G02B 27/0101

(57) ABSTRACT

Disclosed is eye-tracking system (100, 302) comprising: light-emitting units (102a-b), each light-emitting unit comprising light source(s) (108a-b, 202) and means (110a-b, 200) for changing direction of light beam emitted by light source(s), wherein light-emitting units are controlled to emit respective light beams towards user's eye and to change directions of light beams; light sensors (104a-b) to sense reflections of light beams off surface of user's eye; and processor(s) (106) configured to: detect, based on reflections sensed by light sensors, specific direction of light beam at which it is incident upon pupil of user's eye; determine position of pupil, based on specific directions of light beams emitted by light sources of at least two of light-emitting units at which light beams are incident upon pupil and positions of light sources of at least two of light-emitting units; and determine gaze direction of user's eye, based on position of pupil.

### TECHNICAL FIELD

The present disclosure relates to eye-tracking systems. The present disclosure also relates to apparatuses implementing such eye-tracking systems. The present disclosure further relates to methods for eye tracking.

### BACKGROUND

In recent times, there has been rapid advancements in eye-tracking technology. Generally, the eye-tracking technology employs eye-tracking systems that detect and/or track a user's gaze within a visual scene in real time or near-real time. Such eye-tracking systems are being employed in various fields, such as immersive technologies, entertainment, medical imaging operations, simulators, navigation, and the like.

However, existing eye-tracking systems and methods for eye tracking are associated with several limitations. Firstly, some existing eye-tracking systems and methods track a user's eye based on sensing (via light sensors) reflections of ambient light off the user's eye. Often, such reflections are fuzzy in nature, and their strength is considerably dependent on a level of ambient light present in the surroundings of the user and on features (for example, eyelids, eyelashes, epicanthic folds, and the like) of the user's eye. Moreover, the strength of such reflections is highly variable, for example, due to a skin type of the user, a makeup applied by the user around or on his/her eyes, and the like. In such a case, the reflections are very difficult to interpret, and thus, even when their processing utilises significant computational resources and time, the results may still be inaccurate. Secondly, some existing eye-tracking systems and methods employ cameras for tracking the user's eye. However, processing of data collected by the cameras is computationally intensive and time consuming. Moreover, an ideal placement of the cameras required for eye tracking purposes is very difficult to implement, especially when the eye tracking is to be performed for the user using eyeglasses, microscopes, telescopes, or similar.

Therefore, in light of the foregoing discussion, there exists a need to overcome the aforementioned drawbacks associated with existing eye-tracking systems and methods for eye tracking.

### SUMMARY

The present disclosure seeks to provide an eye-tracking system. The present disclosure also seeks to provide an apparatus implementing such an eye-tracking system. The present disclosure further seeks to provide a method for eye tracking. An aim of the present disclosure is to provide a solution that overcomes at least partially the problems encountered in prior art.

In a first aspect, an embodiment of the present disclosure provides an eye-tracking system comprising:
a plurality of light-emitting units, each light-emitting unit comprising at least one light source and means for changing a direction of a light beam emitted by the at least one light source, wherein the plurality of light-emitting units are controlled to emit respective light beams towards a user's eye by employing multiplexing and to change directions of the light beams;
a plurality of light sensors that are to be employed to sense reflections of the light beams off a surface of the user's eye; and
at least one processor configured to:
   detect, based on the reflections sensed by the plurality of light sensors, a specific direction of a light beam emitted by a given light source at which said light beam is incident upon a pupil of the user's eye;
   determine a position of the pupil of the user's eye, based on specific directions of respective light beams emitted by respective light sources of at least two of the plurality of light-emitting units at which the respective light beams are incident upon the pupil and positions of the respective light sources of the at least two of the plurality of light-emitting units; and
   determine a gaze direction of the user's eye, based on the position of the pupil.

In a second aspect, an embodiment of the present disclosure provides an apparatus implementing an eye-tracking system of the first aspect, comprising at least one lens, wherein a first surface of the at least one lens is to face the user's eye when the apparatus is used by the user, wherein the plurality of light-emitting units and the plurality of light sensors are arranged along or in proximity of a periphery of the first surface of the at least one lens.

In a third aspect, an embodiment of the present disclosure provides a method for eye tracking, the method comprising:
controlling a plurality of light-emitting units for emitting respective light beams towards a user's eye by employing multiplexing and for changing directions of the light beams;
employing a plurality of light sensors for sensing reflections of the light beams off a surface of the user's eye;
detecting, based on the reflections sensed by the plurality of light sensors, a specific direction of a light beam emitted by a given light source at which said light beam is incident upon a pupil of the user's eye;
determining a position of the pupil of the user's eye, based on specific directions of respective light beams emitted by respective light sources of at least two of the plurality of light-emitting units at which the respective light beams are incident upon the pupil and positions of the respective light sources of the at least two of the plurality of light-emitting units; and
determining a gaze direction of the user's eye, based on the position of the pupil.

Embodiments of the present disclosure substantially eliminate or at least partially address the aforementioned problems in the prior art, and facilitate a simple, yet accurate and reliable way to determine a gaze direction of a user's eye in real time or near-real time.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic diagram of an eye-tracking system, in accordance with an embodiment of the present disclosure;

FIGS. 2A and 2B illustrate implementations of a means for changing a direction of a light beam emitted by at least one light source, in accordance with different embodiments of the present disclosure;

FIG. 3 is a schematic diagram of a part of an apparatus in which an eye-tracking system is implemented, in accordance with an embodiment of the present disclosure; and

FIG. 4 illustrates steps of a method for eye tracking, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides an eye-tracking system comprising:
a plurality of light-emitting units, each light-emitting unit comprising at least one light source and means for changing a direction of a light beam emitted by the at least one light source, wherein the plurality of light-emitting units are controlled to emit respective light beams towards a user's eye by employing multiplexing and to change directions of the light beams;
a plurality of light sensors that are to be employed to sense reflections of the light beams off a surface of the user's eye; and
at least one processor configured to:
   detect, based on the reflections sensed by the plurality of light sensors, a specific direction of a light beam emitted by a given light source at which said light beam is incident upon a pupil of the user's eye;
   determine a position of the pupil of the user's eye, based on specific directions of respective light beams emitted by respective light sources of at least two of the plurality of light-emitting units at which the respective light beams are incident upon the pupil and positions of the respective light sources of the at least two of the plurality of light-emitting units; and
   determine a gaze direction of the user's eye, based on the position of the pupil.

In a second aspect, an embodiment of the present disclosure provides an apparatus implementing an eye-tracking system of the first aspect, comprising at least one lens, wherein a first surface of the at least one lens is to face the user's eye when the apparatus is used by the user, wherein the plurality of light-emitting units and the plurality of light sensors are arranged along or in proximity of a periphery of the first surface of the at least one lens.

In a third aspect, an embodiment of the present disclosure provides a method for eye tracking, the method comprising:
controlling a plurality of light-emitting units for emitting respective light beams towards a user's eye by employing multiplexing and for changing directions of the light beams;
employing a plurality of light sensors for sensing reflections of the light beams off a surface of the user's eye;
detecting, based on the reflections sensed by the plurality of light sensors, a specific direction of a light beam emitted by a given light source at which said light beam is incident upon a pupil of the user's eye;
determining a position of the pupil of the user's eye, based on specific directions of respective light beams emitted by respective light sources of at least two of the plurality of light-emitting units at which the respective light beams are incident upon the pupil and positions of the respective light sources of the at least two of the plurality of light-emitting units; and
determining a gaze direction of the user's eye, based on the position of the pupil.

The present disclosure provides the aforementioned eye-tracking system, the aforementioned apparatus, and the aforementioned method, which facilitate a simple, yet accurate and reliable way to determine a gaze direction of a user's eye, in real time or near-real time. Herein, the eye-tracking system detects the specific direction of the light beam at which said light beam is incident upon the pupil of the user's eye and determines the position of the pupil of the user's eye (for example, by employing a triangulation technique) for determining the gaze direction of the user's eye. Beneficially, the gaze direction is determined with a high accuracy and precision. Moreover, since the reflections of the emitted light beam are not fuzzy in nature, the reflections are easy to interpret, and their processing is neither computationally intensive and nor time consuming.

Furthermore, the eye-tracking system employs the light sensors, instead of cameras. The eye-tracking system is susceptible to be implemented in various types of apparatuses, for example, such as head-mounted display devices, eyeglasses, microscopes, telescopes, or similar. Moreover, the eye-tracking system is suitable to be integrated with commercially available adaptive eyeglasses.

Throughout the present disclosure, the term “eye-tracking system” refers to a specialized equipment that is employed to detect and/or follow the user's eye for determining the gaze direction of the user's eye. It will be appreciated that the eye-tracking system is arranged in the apparatus in a manner that it does not cause any obstruction in a user's view. Thus, the apparatus utilizes the eye-tracking system for determining the gaze direction of the user's eye via non-invasive techniques. Moreover, an accurate tracking of the gaze direction may facilitate said apparatus to closely implement gaze contingency, for example, such as when presenting an extended-reality (XR) environment to the user, or in case of adaptive eyeglasses. The term “extended-reality” encompasses virtual reality (VR), augmented reality (AR), mixed reality (MR), and the like.

Throughout the present disclosure, the term “light source” refers to an equipment that, in operation, emits the light beam. Examples of the at least one light source include, but are not limited to, a light-emitting diode (LED), a projector, a display, a laser. The laser may be a vertical-cavity surface-emitting laser (VCSEL), an edge-emitting laser (EEL), and the like. Optionally, the light beams are infrared light beams. In other words, the at least one light source and the plurality of light sensors optionally operate on infrared light and can be implemented as at least one infrared light source and a plurality of infrared light sensors. It will be appreciated that the infrared light beams (or near-infrared light beams) are invisible (or imperceptible) to a human eye, thereby, reducing unwanted distraction when such light beams are incident upon the user's eye. This subsequently facilitates in determining the gaze direction of the user's eye with high accuracy. Alternatively, optionally, the light beams are visible light beams. Yet alternatively, optionally, the light beams are ultraviolet light beams. In such a case, the at least one light source and the plurality of light sensors optionally operate on ultraviolet light and can be implemented as at least one ultraviolet light source and a plurality of ultraviolet light sensors. In this regard, ultraviolet light in a range of wavelengths that is not harmful to the human eye is selected. For example, a wavelength of the selected ultraviolet light may lie in a range of 315 nm to 400 nm.

It will be appreciated that when the plurality of light-emitting units are controlled to emit respective light beams towards the user's eye by employing multiplexing, a plurality of light sources are interleaved in a manner that said light sources are well-synchronized with each other with respect to their operations, and thus do not interfere with each other during their operation. Moreover, such a multiplexing facilitates in simultaneously measuring data from multiple directions, for example, using signal modulation and/or encoding. The multiplexing could comprise at least one of: time-division multiplexing, wavelength-division multiplexing, polarisation-division multiplexing, code-division multiplexing. The term “time-division multiplexing” refers to a time-based interleaving of the plurality of light sources, wherein a given light source emits the light beam towards the user's eye in a given time slot and/or at a given framerate only. Furthermore, the term “wavelength-division multiplexing” refers to a wavelength-based interleaving of the plurality of light sources, wherein different light sources have a capability to employ different wavelengths of light beams. Moreover, the term “polarisation-division multiplexing” refers to a polarisation-based interleaving of the plurality of light sources, wherein different light sources have a capability to employ different polarization states for emitting the light beam. Furthermore, the term “code-division multiplexing” refers to a code-based interleaving of the plurality of light sources, wherein different light sources have a capability to employ different optical codes for emitting the light beam.

Moreover, the aforesaid means is controlled (by the at least one processor) to steer the light beam, i.e., to change an optical path of the light beam, for changing the direction of the light beam. In an embodiment, the means for changing the direction of the light beam emitted by the at least one light source is implemented as a liquid crystal lens arranged in front of a light-emitting surface of the at least one light source. Optionally, in this regard, the liquid crystal lens is electrically controlled by the at least one processor, to change the direction of the light beam emanating from the light-emitting surface of the at least one light source. In such a case, the at least one processor sends a drive signal to drive a control circuit of the liquid crystal lens to control liquid-crystal molecules contained within the liquid crystal lens, so as to change the direction of the light beam emanating from the light-emitting surface of the at least one light source. It will be appreciated that the liquid crystal lens could be provided with different levels of drive signals to control molecular alignment (namely, orientation) of the liquid crystal molecules, thereby changing the direction of the light beam. This is because different molecular alignments of the liquid crystal molecules would result in different beam emission angles.

In another embodiment, the means for changing the direction of the light beam emitted by the at least one light source is implemented as an actuator that is employed to adjust an orientation of the at least one light source. Optionally, in this regard, the actuator changes an orientation of the at least one light source, so as to change the direction of the light beam emitted by the at least one light source. Optionally, the at least one processor is configured to control the actuator by way of an actuation signal. The actuation signal physically rotates and/or tilts the at least one light source to change the orientation of the at least one light source. Different rotations and/or tilts would result in different beam emission angles. The actuation signal could be, for example, an electrical signal, a hydraulic signal, a pneumatic signal, or similar. Herein, the term “actuator” refers to an equipment that is employed to rotate and/or tilt the at least one light source to which it is connected (directly or indirectly). Such an actuator may, for example, include electrical components, mechanical components, magnetic components, polymeric components, and the like.

In some implementations, said means is configured to change the direction of the light beam during a time period between two consecutive emissions of the light beam by the at least one light source. In this regard, the direction of the light beam would remain the same during the emission of the light beam, i.e., the light beam does not appear to be (continuously) moving during the emission. In such a case, the reflections of the light beams off the surface of the user's eye for the two consecutive emissions would be sensed individually (i.e., the strength of the reflections would be measured separately for the two consecutive emissions). Beneficially, this facilitates in efficiently employing the multiplexing (for example, such as code-division multiplexing) for emitting the light beams towards the user's eye. This also allows for saving processing resources of the at least one processor.

In other implementations, said means is configured to change the direction of the light beam during emission of the light beam by the at least one light source. In this regard, the direction of the light beam would not remain the same during the emission, i.e., the light beam appears to be (continuously) moving during its emission as its direction is changing. In such a case, the reflections of the light beam off the surface of the user's eye would be sensed continuously (i.e., the strength of the reflections would be measured continuously). This allows for continuously scanning smaller sub-areas of the user's eye, thereby facilitating in determining the position of the pupil of the user's eye with a higher precision and a lower latency (i.e., in real time or near-real time, without any delay).

It will be appreciated that sensing multiple reflections simultaneously could be feasible with both the aforementioned implementations. Sensing multiple reflections simultaneously would facilitate a lower latency and a higher accuracy in determining the position of the pupil of the user's eye, since the reflections are received at a same point of time. However, in such a scenario, there would be a trade-off between processing complexity and processing resource utilization of the at least one processor.

Throughout the present disclosure, the term “light sensor” refers to an equipment that is operable to detect (namely, sense) the reflections of the light beams off the surface of the user's eye. Optionally, a given light sensor is implemented as at least one of: an IR light sensor, a visible light sensor, a UV light sensor.

In an example implementation, the at least one light source and the given light sensor are arranged at fixed positions in the eye-tracking system. For a given light source, only the direction of the light beam (that is emitted by the given light source) is changed to scan the user's eye (for determining the pupil of the user's eye).

Notably, the at least one processor may control an overall operation of the eye-tracking system. For this purpose, the at least one processor is at least communicably coupled to the plurality of light-emitting units (specifically, to the at least one light source and to the means for changing the direction of the light beam), and the plurality of light sensors. It will be appreciated that the at least one processor may include a microcontroller or a microprocessor to control operations of the plurality of light sources and the plurality of light sensors.

It will be appreciated that in an alternative implementation, the at least one processor may not control the plurality of light sources to emit the light beams for scanning the user's eye, and thus emission of said light beams could be implemented by using an analog signal feedback, for example, such as in servo control. Such an implementation is typically very fast, and is simple in construction. In such an implementation, a feedback measurement directly controls the actuators.

Notably, when the plurality of light sources emit the respective light beams towards the user's eye, the respective light beams are incident upon different parts of the user's eye. Such parts of the user's eye could be, for example, such as an iris, a sclera, a pupil, and the like. In this regard, there might be an instant of time in which the light beam emitted by a given light source is incident upon the pupil of the user's eye. The specific direction of the light beam at said instant of time is detected based on the reflections. In an example of time-division multiplexing, when the light beams are emitted from the plurality of light sources in a sequential (i.e., one-by-one) manner, the at least one processor could easily detect when the light beam emitted by the given light source is actually incident on the pupil of the user's eye. As the at least one processor controls the operation of the plurality of light sources, the at least one processor already accurately knows which light source emitted the light beam at a given instant of time. Therefore, when said light beam is incident upon the pupil of the user's eye, the at least one processor knows the position of the given light source (from which the light beam emitted at the given instant of time) and the direction of the light beam.

Optionally, a given light beam is detected to be incident upon the pupil when no reflection of the given light beam is sensed by any of the plurality of light sensors. In this regard, since a pupil of a human eye absorbs (almost) all light that is incident thereupon, there would not be any reflection of said light off the pupil of the user's eye. Therefore, when the given light beam is incident upon the pupil, there would not be any reflection of the given light beam that is sensed by any of the plurality of light sensors. In other words, the given light beam that is incident upon the pupil disappears completely and there would not be any reflection (i.e., a strength of the sensed reflection would be zero).

Optionally, a given light beam is detected to be incident upon the pupil when a reflection of the given light beam as sensed by at least one of the plurality of light sensors is attenuated by at least a predefined percent. In this regard, when the given light beam is incident upon the pupil, only a portion of the given light beam may be absorbed by the pupil (i.e., the given light beam only disappears partly) and a remaining portion of the given light beam that is not absorbed by the pupil is reflected off (the pupil of) the user's eye. Thus, the reflection of the given light beam as sensed by the at least one of the plurality of light sensors is attenuated (namely, reduced) by at least the predefined percent, for the light beam to be considered to be incident upon the pupil.

The predefined percent (by which the reflected light signal should be attenuated to be considered to be incident upon the pupil) depends on encoding of a light signal. As an example, for a signal-to-noise ratio (SNR) of 70 decibels of a reflected light signal (namely, a reflection), the predefined percent could be as low as 0.1 percent. The SNR of 70 decibels means that 1 out of 10000000 would be detectable in the reflected light signal. An actual SNR may be at least 100 or 1000 times of 70 decibels, considering that there is absorbing light signal in the reflected light signal.

Notably, since the specific directions of the respective light beams that are incident upon the pupil and the positions of the respective light sources are already accurately known to the at least one processor, the position of the pupil of the user's eye can be ascertained by employing a triangulation technique. Such a triangulation technique may be based on trigonometry. Such triangulation techniques are well-known in the art. Moreover, it will be appreciated that the gaze direction of the user's eye could also be determined using a correlation, without a need to determine the position of the pupil in a three-dimensional (3D) space using the triangulation technique.

Notably, different positions of the pupil correspond to different gaze directions of the user's eye. Once the position of the pupil is known to the at least one processor, the gaze direction of the user's eye can be easily determined by the at least one processor. As the pupil of the user's eye is oriented along the gaze direction of the user's eye, the (determined) position of the pupil enables the at least one processor to correctly determine the gaze direction of the user's eye. As an example, when the position of the pupil is towards a left side of the user's eye, the gaze direction of the user's eye is towards a left side of a field of view of the user's eye.

In this manner, the at least one processor could determine gaze directions of the user's eye based on some approximations, even without any calibration. Typically, human eyes can easily discern where a person's eye is gazing just by looking at the person's eye. Similarly, the at least one processor is configured to determine (approximate) gaze directions of the user's eye, just by knowing the position of the pupil of the user's eye. Moreover, development of a human eye vision in childhood typically allows human eyes to develop so that a sharp vision area of the human eye with respect to an optical axis of the human eye varies slightly amongst individuals. Thus, different users would have different actual gaze directions. Furthermore, some individuals have vision issues that make their eyes to have a limited movement capabilities in varying degrees. In such a case, it would be difficult to implement the calibration of the eye-tracking system beforehand. Thus, the at least one processor determines gaze directions of the user's eye based on some approximations.

Optionally, the at least one processor is configured to:
determine a correlation between different positions of the pupil and respective gaze directions of the user's eye, during an initial calibration of the eye-tracking system for the user's eye; and
utilise the correlation between the different positions of the pupil and the respective gaze directions of the user's eye, when determining the gaze direction of the user's eye.

In this regard, in order to be able to determine the gaze direction from the position of the pupil, the correlation (between different positions of the pupil and different gaze directions) is required to be known beforehand, thus the initial calibration of the eye-tracking system is performed.

In an example, during the initial calibration, the user may be required to wear a wearable device that comprises the eye-tracking system, and to view at least one reference image displayed on a display of the wearable device (or to view at least one reference image displayed on an external display through the wearable device). Herein, the term “reference image” refers to an image that is to be used for calibrating the eye-tracking system for the user's eye. Optionally, in this regard, the at least one reference image presents to the user a given visual target at a given location on the display or the external display. The term “visual target” refers to a visible mark that is represented within the at least one reference image and is distinctly visible in the at least one reference image. Different locations of the given visual target correspond to the different positions of the pupil and the respective gaze directions of the user's eye. The given visual target could be represented, for example, at a central portion, a corner portion, a top portion, a right side portion, a left side portion, and the like, within the at least one reference image. As an example, when the given visual target is at the central portion within the at least one reference image, the at least one processor could easily ascertain that the position of the pupil would be at a centre of the user's eye, and thus a gaze of the user's eye would be towards a central region of a field of view of the user's eye. As another example, when the given visual target is at the right side portion within the at least one reference image, the at least one processor could easily ascertain that the position of the pupil would be towards a right side of the user's eye, and thus the gaze direction of the user's eye would be towards a right side region of a field of view of the user's eye. Since the at least one processor controls displaying of the at least one reference image, the given location of the given visual target is already known to the at least one processor. In this regard, the at least one processor is configured to determine the correlation between the different positions of the pupil and the respective gaze directions of the user's eye, based on the given location of the given visual target. In this way, the at least one processor utilises the correlation for determining subsequent gaze directions of the user's eye. The wearable device could be, for example, such as an eye glass, a head-mounted display (HMD) device, and the like.

In another example, during the initial calibration, the user may be required to wear the wearable device comprising the eye-tracking system, and to focus on the given visual target represented within the at least one reference image while rotating his/her head. In yet another example, the calibration is not performed prior to using the eye-tracking system, but is performed during use of the wearable device comprising the eye-tracking system. In such a case, an initial error in the determined gaze direction may be high. Moreover, a machine learning model may be employed by the at least one processor to determine (and subsequently utilise) the correlation between the different positions of the pupil and the respective gaze directions of the user's eye.

Optionally, the at least one processor is configured to:
determine at least one of: a size, a shape of the pupil, based on the specific directions of the respective light beams emitted by the respective light sources of the at least two of the plurality of light-emitting units at which the respective light beams are incident upon the pupil and the positions of the respective light sources of the at least two of the plurality of light-emitting units; and
determine the gaze direction of the user's eye, further based on the at least one of: the size, the shape of the pupil.

Since the at least one processor controls the operation of the plurality of light sources, the at least one processor already accurately knows the positions of the respective light sources (from which the respective light beams have been emitted) and the specific directions of the respective light beams. Moreover, the at least one processor already accurately knows information (for example, such as a width, a wavelength, a frequency, and the like) pertaining to a given light beam emitted by a given light source. Therefore, the at least one processor could be configured to determine the size and/or shape of the pupil. Herein, the phrase “shape of pupil” refers to a shape of the pupil as visible from a given position of the given light source. It will be appreciated that an actual shape of the pupil would remain round (namely, circular), but may appear to have different shapes from different directions.

Moreover, when the shape of the pupil is round, the at least one processor may determine that the pupil is at the centre of the user's eye, and thus the gaze direction of the user's eye lies towards a central region of the field of view of the user's eye. When the shape of the pupil is not round but, for example, is oval, the at least one processor may determine the gaze direction of the user's eye based on an orientation of the oval shape of the pupil. Furthermore, when the user is gazing at a nearby object, the size of the pupil is smaller as compared when the user is gazing at a faraway object. This is because the pupil generally dilates when the user is gazing afar.

It will be appreciated that the at least one processor could be configured to determine the size and/or shape of the pupil even when the given light beam is wider than the size of the pupil of the user's eye. In such a case, a difference between a strength of the light beam emitted by a given light source and a strength of the reflection is smaller. Moreover, when light sensors sense such reflections of the light beam, the light sensors oversample reflected light signals with a considerably high margin, and an amount of the reflected light signals correlates with the size and/or shape of the pupil. Furthermore, edges of the pupil can be scanned, even when the given light beam is wider than the size of the pupil of the user's eye. The shape of the pupil could be ascertained from a field of view of the light sensor.

The present disclosure also relates to the apparatus as described above. Various embodiments and variants disclosed above, with respect to the aforementioned first aspect, apply mutatis mutandis to the apparatus.

The apparatus implementing the eye-tracking system could be, for example, an eyeglass, a head-mounted display (HMD), a microscope, a telescope, a camera, or the like. Herein, the term “head-mounted display” device refers to an equipment that presents an extended-reality (XR) environment to a user when said HMD device, in operation, is worn by the user on his/her head. The HMD device is implemented, for example, as an XR headset, a pair of XR glasses, and the like, that is operable to display a visual scene of an XR environment to the user.

The at least one lens could be a concave lens, a convex lens, a bifocal lens, a liquid crystal lens, a Fresnel lens, a liquid crystal Fresnel lens or the like. Since eye tracking is to be performed for the user's eye when the apparatus is used by the user, the first surface of the at least one lens faces the user's eye. It will be appreciated that arranging the plurality of light-emitting units and the plurality of light sensors along or in the proximity of the periphery of the first surface of the at least one lens facilitates in emitting the light beams towards the user's eye, changing the directions of the light beams, and sensing the reflections of the light beams for accurate eye tracking.

The present disclosure also relates to the method as described above. Various embodiments and variants disclosed above, with respect to the aforementioned first aspect, apply mutatis mutandis to the method.

Optionally, the method further comprises:
determining at least one of: a size, a shape of the pupil, based on the specific directions of the respective light beams emitted by the respective light sources of the at least two of the plurality of light-emitting units at which the respective light beams are incident upon the pupil and the positions of the respective light sources of the at least two of the plurality of light-emitting units; and
determining the gaze direction of the user's eye, further based on the at least one of: the size, the shape of the pupil.

Optionally, the method further comprises:
determining a correlation between different positions of the pupil and respective gaze directions of the user's eye, during an initial calibration of the eye-tracking system for the user's eye; and
utilising the correlation between the different positions of the pupil and the respective gaze directions of the user's eye, when determining the gaze direction of the user's eye.

Optionally, the method further comprises detecting a given light beam to be incident upon the pupil when no reflection of the given light beam is sensed by any of the plurality of light sensors.

Optionally, the method further comprises detecting a given light beam to be incident upon the pupil when a reflection of the given light beam as sensed by at least one of the plurality of light sensors is attenuated by at least a predefined percent.

Pursuant to embodiments, each light-emitting unit comprises at least one light source and means for changing a direction of a light beam emitted by the at least one light source. Optionally, in the method, said means is implemented as a liquid crystal lens arranged in front of a light-emitting surface of the at least one light source. Alternatively, optionally, in the method, said means is implemented as an actuator that is employed to adjust an orientation of the at least one light source.

Optionally, in the method, said means is configured to change the direction of the light beam during a time period between two consecutive emissions of the light beam by the at least one light source.

Optionally, in the method, said means is configured to change the direction of the light beam during emission of the light beam by the at least one light source.

Optionally, in the method, the light beams are infrared light beams.

### DETAILED DESCRIPTION OF THE DRAWINGS

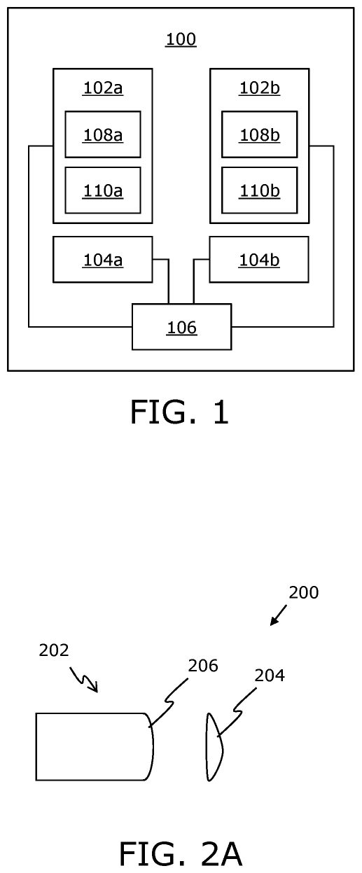

Referring to FIG. 1, illustrated is an eye-tracking system 100, in accordance with an embodiment of the present disclosure. The eye-tracking system 100 comprises a plurality of light-emitting units (depicted as light-emitting units 102a and 102b), a plurality of light sensors (depicted as light sensors 104a and 104b), and at least one processor (depicted as a processor 106). Each light-emitting unit 102a-b comprises at least one light source (depicted as light sources 108a and 108b of the light-emitting units 102a and 102b, respectively) and means (depicted as means 110a and 110b of the light-emitting units 102a and 102b, respectively) for changing a direction of a light beam emitted by the at least one light source 108a and 108b. The light-emitting units 102a-b are controlled to emit respective light beams towards a user's eye (not shown) by employing multiplexing and to change the directions of the light beams. The plurality of light sensors 104a-b are to be employed to sense reflections of the light beams off a surface of the user's eye. The at least one processor 106 is coupled to the plurality of light-emitting units 102a-b and the plurality of light sensors 104a-b.

It may be understood by a person skilled in the art that FIG. 1 includes a simplified architecture of the eye-tracking system 100 for sake of clarity, which should not unduly limit the scope of the claims herein. The person skilled in the art will recognize many variations, alternatives, and modifications of embodiments of the present disclosure.

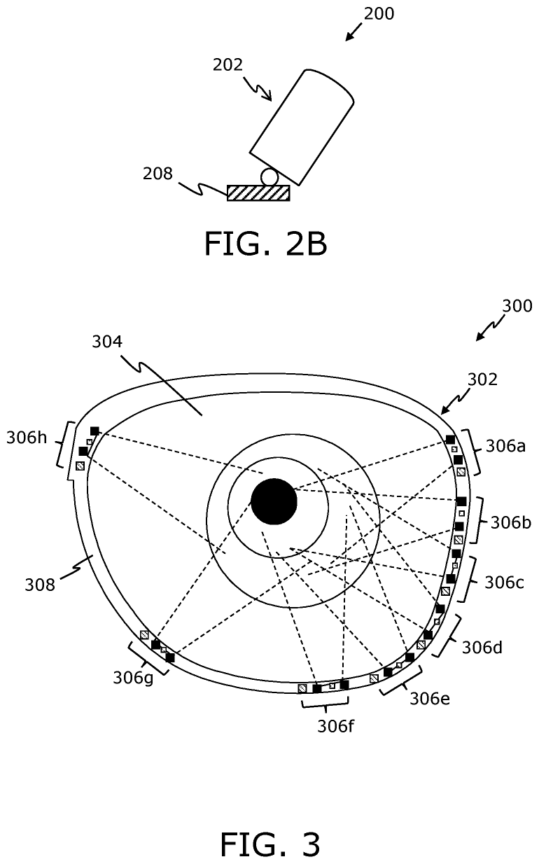

Referring to FIG. 2A, illustrated is an implementation of a means 200 for changing a direction of a light beam emitted by at least one light source (depicted as a light source 202), in accordance with an embodiment of the present disclosure. The means 200 is implemented as a liquid crystal lens 204 arranged in front of a light-emitting surface 206 of the light source 202.

Referring to FIG. 2B, illustrated is another implementation of a means 200 for changing a direction of a light beam emitted by at least one light source (depicted as a light source 202), in accordance with an embodiment of the present disclosure. The means 200 is implemented as an actuator 208 that is employed to adjust an orientation of the light source 202. The actuator 208 is connected to the light source 202.

It may be understood by a person skilled in the art that FIGS. 2A and 2B include simplified implementations of the means 200 for sake of clarity, which should not unduly limit the scope of the claims herein. The person skilled in the art will recognize many variations, alternatives, and modifications of embodiments of the present disclosure.

Referring to FIG. 3, illustrated is a schematic diagram of a part of an apparatus 300 in which an eye-tracking system 302 is implemented, in accordance with an embodiment of the present disclosure. The apparatus 300 comprising at least one lens (depicted as a lens 304), wherein a first surface of the at least one lens is to face a user's eye when the apparatus is used by the user. The eye-tracking system 302 comprises a plurality of light-emitting units, a plurality of light sensors (depicted as slanted-hatched squares), and at least one processor (not shown). Each light-emitting unit comprises at least one light source (depicted as solid squares) and means (depicted as dotted-hatched squares) for changing a direction of a light beam emitted by the at least one light source.

The plurality of light-emitting units and the plurality of light sensors of the eye-tracking system 302 are arranged along or in proximity of a periphery of the first surface of the at least one lens, as shown. There are shown, for example, multiple groups 306a-h of constituent elements of the eye-tracking system 302 arranged along a periphery 308 of the first surface of the lens 304.

FIG. 3 is merely an example, which should not unduly limit the scope of the claims herein. The person skilled in the art will recognize many variations, alternatives, and modifications of embodiments of the present disclosure.

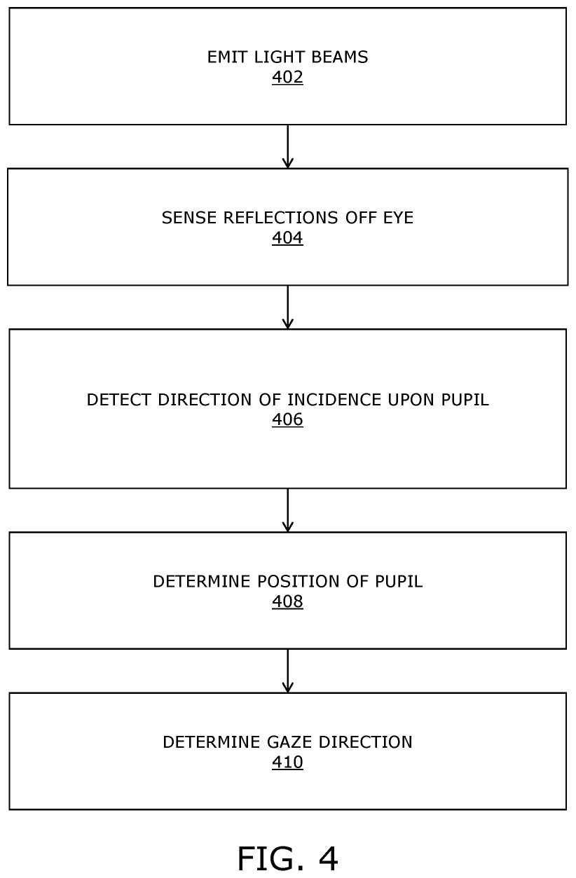

Referring to FIG. 4, illustrated are steps of a method for eye tracking, in accordance with an embodiment of the present disclosure. At step 402, a plurality of light-emitting units are controlled for emitting respective light beams towards a user's eye by employing multiplexing and for changing directions of the light beams. At step 404, a plurality of light sensors are employed for sensing reflections of the light beams off a surface of the user's eye. At step 406, a specific direction of a light beam emitted by a given light source at which said light beam is incident upon a pupil of the user's eye is detected, based on the reflections sensed by the plurality of light sensors. At step 408, a position of the pupil of the user's eye is determined, based on specific directions of respective light beams emitted by respective light sources of at least two of the plurality of light-emitting units at which the respective light beams are incident upon the pupil and positions of the respective light sources of the at least two of the plurality of light-emitting units. At step 410, a gaze direction of the user's eye is determined, based on the position of the pupil.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An eye-tracking system comprising:
a plurality of light-emitting units, each light-emitting unit comprising at least one light source and means for changing a direction of a light beam emitted by the at least one light source, wherein the plurality of light-emitting units are controlled to emit respective light beams towards a user's eye by employing multiplexing and to change directions of the light beams;
a plurality of light sensors that are to be employed to sense reflections of the light beams off a surface of the user's eye; and
at least one processor configured to:
detect, based on the reflections sensed by the plurality of light sensors, a specific direction of a light beam emitted by a given light source at which said light beam is incident upon a pupil of the user's eye;
determine a position of the pupil of the user's eye, based on specific directions of respective light beams emitted by respective light sources of at least two of the plurality of light-emitting units at which the respective light beams are incident upon the pupil and positions of the respective light sources of the at least two of the plurality of light-emitting units; and
determine a gaze direction of the user's eye, based on the position of the pupil.

2. The eye-tracking system of claim 1, wherein the at least one processor is configured to:
determine at least one of: a size, a shape of the pupil, based on the specific directions of the respective light beams emitted by the respective light sources of the at least two of the plurality of light-emitting units at which the respective light beams are incident upon the pupil and the positions of the respective light sources of the at least two of the plurality of light-emitting units; and
determine the gaze direction of the user's eye, further based on the at least one of: the size, the shape of the pupil.

3. The eye-tracking system of claim 1, wherein the at least one processor is configured to:
determine a correlation between different positions of the pupil and respective gaze directions of the user's eye, during an initial calibration of the eye-tracking system for the user's eye; and
utilise the correlation between the different positions of the pupil and the respective gaze directions of the user's eye, when determining the gaze direction of the user's eye.

4. The eye-tracking system of claim 1, wherein a given light beam is detected to be incident upon the pupil when no reflection of the given light beam is sensed by any of the plurality of light sensors.

5. The eye-tracking system of claim 1, wherein a given light beam is detected to be incident upon the pupil when a reflection of the given light beam as sensed by at least one of the plurality of light sensors is attenuated by at least a predefined percent.

6. The eye-tracking system of claim 1, wherein the means for changing the direction of the light beam emitted by the at least one light source is implemented as a liquid crystal lens arranged in front of a light-emitting surface of the at least one light source.

7. The eye-tracking system of claim 1, wherein the means for changing the direction of the light beam emitted by the at least one light source is implemented as an actuator that is employed to adjust an orientation of the at least one light source.

8. The eye-tracking system of claim 1, wherein said means is configured to change the direction of the light beam during a time period between two consecutive emissions of the light beam by the at least one light source.

9. The eye-tracking system of claim 1, wherein said means is configured to change the direction of the light beam during emission of the light beam by the at least one light source.

10. The eye-tracking system of claim 1, wherein the light beams are infrared light beams.

11. An apparatus implementing the eye-tracking system of claim 1, comprising at least one lens, wherein a first surface of the at least one lens is to face the user's eye when the apparatus is used by the user, wherein the plurality of light-emitting units and the plurality of light sensors are arranged along or in proximity of a periphery of the first surface of the at least one lens.

12. A method for eye tracking, the method comprising:
controlling a plurality of light-emitting units for emitting respective light beams towards a user's eye by employing multiplexing and for changing directions of the light beams;
employing a plurality of light sensors for sensing reflections of the light beams off a surface of the user's eye;
detecting, based on the reflections sensed by the plurality of light sensors, a specific direction of a light beam emitted by a given light source at which said light beam is incident upon a pupil of the user's eye;
determining a position of the pupil of the user's eye, based on specific directions of respective light beams emitted by respective light sources of at least two of the plurality of light-emitting units at which the respective light beams are incident upon the pupil and positions of the respective light sources of the at least two of the plurality of light-emitting units; and
determining a gaze direction of the user's eye, based on the position of the pupil.

13. The method of claim 12, further comprising:
determining at least one of: a size, a shape of the pupil, based on the specific directions of the respective light beams emitted by the respective light sources of the at least two of the plurality of light-emitting units at which the respective light beams are incident upon the pupil and the positions of the respective light sources of the at least two of the plurality of light-emitting units; and
determining the gaze direction of the user's eye, further based on the at least one of: the size, the shape of the pupil.

14. The method of claim 12 or 13, further comprising:
determining a correlation between different positions of the pupil and respective gaze directions of the user's eye, during an initial calibration of the eye-tracking system for the user's eye; and
utilising the correlation between the different positions of the pupil and the respective gaze directions of the user's eye, when determining the gaze direction of the user's eye.

15. The method of claim 12, further comprising detecting a given light beam to be incident upon the pupil when no reflection of the given light beam is sensed by any of the plurality of light sensors.

16. The method of claim 12, further comprising detecting a given light beam to be incident upon the pupil when a reflection of the given light beam as sensed by at least one of the plurality of light sensors is attenuated by at least a predefined percent.

17. The method of claim 12, wherein each light-emitting unit comprises at least one light source and means for changing a direction of a light beam emitted by the at least one light source, wherein said means is implemented as a liquid crystal lens arranged in front of a light-emitting surface of the at least one light source.

18. The method of claim 12, wherein each light-emitting unit comprises at least one light source and means for changing a direction of a light beam emitted by the at least one light source, wherein said means is implemented as an actuator-R that is employed to adjust an orientation of the at least one light source.

19. The method of claim 12, wherein each light-emitting unit comprises at least one light source and means for changing a direction of a light beam emitted by the at least one light source, wherein said means is configured to change the direction of the light beam during a time period between two consecutive emissions of the light beam by the at least one light source.

20. The method of claim 12, wherein each light-emitting unit comprises at least one light source and means for changing a direction of a light beam emitted by the at least one light source, wherein said means is configured to change the direction of the light beam during emission of the light beam by the at least one light source.
